(19) United States
(12) Patent Application Publication
(10) Pub. No.: US 2011/0235924 A1
(43) Pub. Date: Sep. 29, 2011

(54) METHOD FOR ORGANIZING A DIGITAL IMAGE ACCORDING TO FACIAL FEATURES OF MEMBERS IN THE DIGITAL IMAGE

(76) Inventors: Xian-Ji Wang, Hangzhou City (CN); Kun Yu, Hangzhou City (CN); Shu Li, Hangzhou City (CN); Jin Wang, Hangzhou City (CN)

(21) Appl. No.: 12/732,180

(22) Filed: Mar. 25, 2010

(51) Int. Cl. G06K 9/62; G06K 9/68

(52) U.S. Cl. 382/218

(57) ABSTRACT

After receiving a digital image, check if the digital image contains a predetermined object. If the digital image contains the predetermined object, extract object features from the predetermined object, then compare the object features with common features of each of the predetermined identifications. If the object features match the common features of one of the predetermined identifications, store the digital image into a database dedicated to the predetermined identification. If the object features do not match the common features of any of the predetermined identifications, register the predetermined object with a new identification. If the new identification is the same as one of the predetermined identifications, store the digital image into a database dedicated to the predetermined identification. If the new identification is different from all of the predetermined identifications, store the digital image into a database dedicated to the new identification.

### BACKGROUND OF THE INVENTION

1. Field of the Invention

The present invention relates to a method for organizing a digital image, more particularly, to a method for organizing a digital image according to facial features of members in the digital image.

2. Description of the Prior Art

As digital image capturing devices such as digital cameras, camera-attached mobile phones, webcams, and digital camcorders become more popular, and memory space inside the digital image capturing devices increases dramatically, people are using their digital image capturing devices to take digital image pictures wherever they go without having a second thought. This creates a huge amount of digital images. Although it is quite entertaining to take many pictures, organizing all these pictures is very tedious and time consuming. Thus many users simply transfer these pictures to a hard disc without organizing the pictures. But since these pictures are not organized, when a user tries to review one of his or her friends' pictures, the user may have to spend a lot of time and effort just to dig out a small number of his or her friend's pictures from a huge amount of digital images. Not to mention the situation when the user only has one or two of his or her friend's pictures, it would be like looking for a needle in a bottle of hay. The user may never be able to find his or her friend's pictures. Further, if the user has not contacted his or her friend for a long time, the user may even forget about this very friend since the user may unintentionally skip this friend's picture when the user reviews his or her unorganized pictures in the user's hard disc.

To avoid the problem, a prior art method for organizing digital images has been developed. The prior art attaches a tag to each digital image. Such a tag usually includes a name or another recognizable identity. Unfortunately, most digital image capturing devices do not provide this functionality. Moreover manually attaching tags to a large amount of digital images takes too much effort and too much time. It is unrealistic to have a busy person spending so much time to fill out tags for digital images because filling out tags is very dull and frustrating.

### SUMMARY OF THE INVENTION

According to an embodiment of the present invention, a method for organizing a digital image comprises receiving a digital image and checking if the digital image contains a predetermined object. If the digital image contains the predetermined object, extract object features from the predetermined object, then compare the object features with common features of each predetermined identification. If the object features match the common features of the predetermined identification, store the digital image into a database dedicated to the predetermined identification.

According to another embodiment of the present invention, a method for organizing a digital image comprises receiving a digital image and checking if the digital image contains a predetermined object. If the digital image contains the predetermined object, extract object features from the predetermined object, then compare the object features with common features of each predetermined identification. If the object features do not match the common features of the predetermined identification, register the predetermined object with a new identification.

According to another embodiment of the present invention, a method for organizing a digital image comprises receiving a digital image and checking if the digital image contains a plurality of predetermined objects. If the digital image contains the plurality of predetermined objects, extract object features from one of the predetermined objects, then compare the object features with common features of each predetermined identification. Lastly, store the digital image according to whether the object features match the common features of the predetermined identification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of organizing a digital image according to an embodiment of the present invention.

FIG. 2 is a flow chart of organizing a digital image according to another embodiment of the present invention.

### DETAILED DESCRIPTION

To avoid filling out tags and attaching tags to digital images one by one, the present invention is developed to classify digital images automatically.

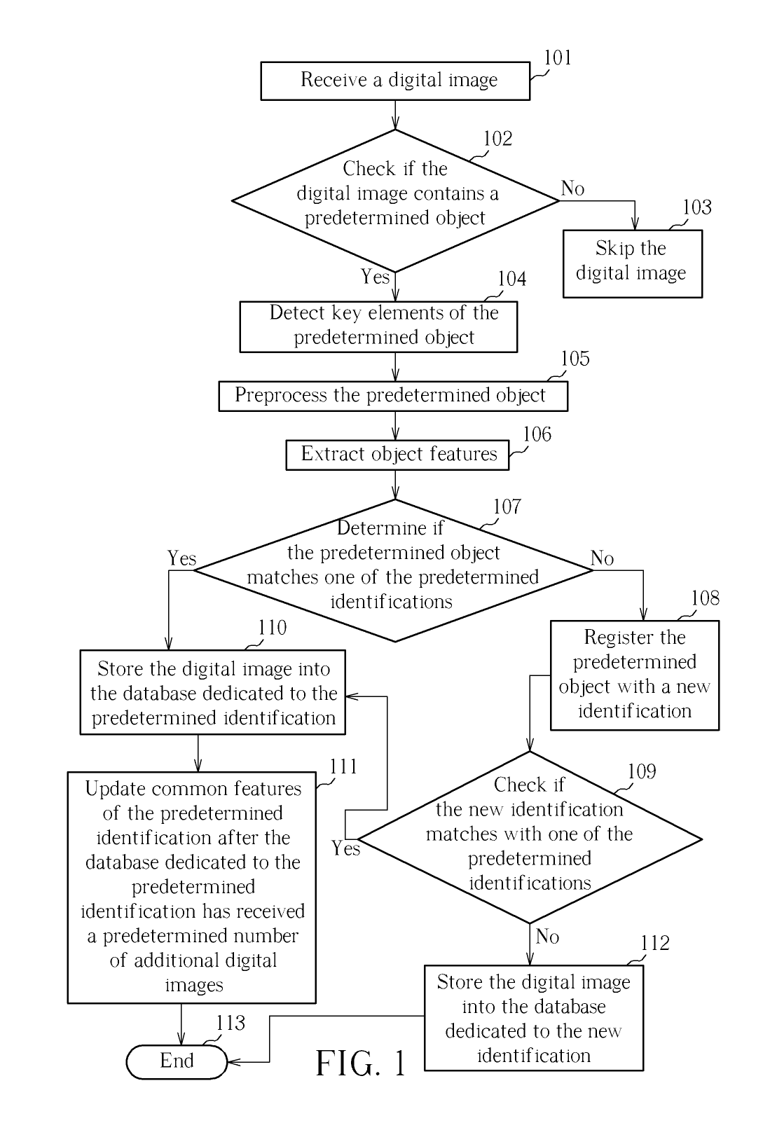

Please refer to FIG. 1. FIG. 1 is a flowchart of a method for organizing a digital image according to a first embodiment of the present invention. The method for organizing a digital image includes the following steps:

Step 101: Receive a digital image from a digital camera, camera-attached mobile phone, digital camcorder, webcam or internet;

Step 102: Check if the digital image contains a predetermined object, such as a human face. If not, go to step 103; if so, go to step 104;

Step 103: Skip the digital image;

Step 104: Detect key elements of the predetermined object such as eyes, nose, mouth, forehead, ears, chin, and face shape;

Step 105: Preprocess the predetermined object, such as aligning the face to a canonical coordinate by rotating, rescaling, and translating the human face, and improving robustness of the human face against illumination variation by performing photometric normalization on the aligned face;

Step 106: Extract object features of the predetermined object, such as a key element vector, textures of a key element, shape of a key element, dimensions of a key element, and colors of a key element. A key element vector can be the position of a geographic center of a key element (e.g. eyes, nose, mouth, forehead, ears, chin, and face shape) with respect to another coordinate such as an origin;

Step 107: Compare the object features with common features of each of the predetermined identifications to determine whether the predetermined object matches one of the predetermined identifications. If not, go to step 108; if so, go to step 110;

Step 108: Register the predetermined object of the digital image with a new identification;

Step 109: Check if the new identification matches with one of the predetermined identifications. If so, go to step 110; if not, go to step 112;

Step 110: Store the digital image into the database dedicated to the predetermined identification;

Step 111: Update common features of the predetermined identification after the database dedicated to the predetermined identification has received a predetermined number of additional digital images so as to improve recognition accuracy of following digital images in step 107;

Step 112: Store the digital image into the database dedicated to the new identification;

Step 113: End.

At the initial stage, there may not be any predetermined identification. In that case, the comparison of the object features extracted in step 106 with common features of each of the predetermined identifications in step 107 would conclude that the predetermined object does not match any one of the predetermined identifications. Thus the predetermined object of the digital image would be registered with a new identification (e.g. A0001) in step 108. And the digital image would be stored into the database dedicated to the new identification (A0001) in step 112.

After a predetermined number of digital images have been stored into the database dedicated to the new identification (A0001), common features of the new identification (A0001) can be generated from the object features of the predetermined object in different digital images. Once the common features of the new identification (A0001) are generated, the new identification (A0001) becomes one of the predetermined identifications. And then object features of a predetermined object extracted from a following digital image in step 106 will be compared with the common features of the identification (A0001).

As shown in step 111, although the common features of the identification (A0001) have been generated, after the database dedicated to the identification (A0001) has received a predetermined number of additional digital images, the common features of the identification (A0001) can be updated based on the object features of the predetermined object in all of the digital images stored in the database dedicated to the identification (A0001). This will increase the sturdiness of the common features of the identification (A0001).

In step 107, if the comparison result shows that the object features match common features of two or even more predetermined identifications, then the digital image would be stored into the database dedicated to the predetermined identification which matches the object features most.

If step 103, instead of skipping the digital image, the digital image can be stored into a database classified as not having any predetermined object (e.g. a face), or the user may have to decide where to store the digital image.

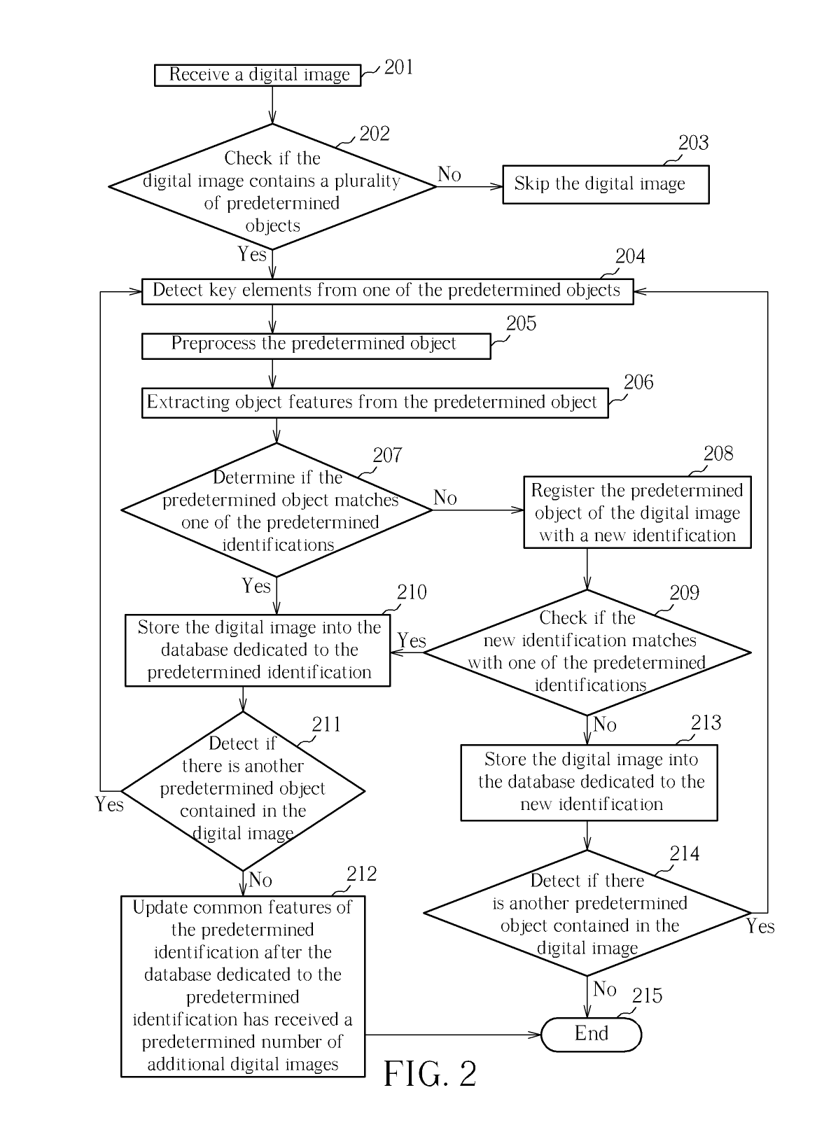

Please refer to FIG. 2. FIG. 2 is a flowchart of a method for organizing a digital image according to a second embodiment of the present invention. The method includes the following steps:

Step 201: Receive a digital image from a digital device, such as a digital camera, camera-attached mobile phone, digital camcorder, or internet;

Step 202: Check if the digital image contains a plurality of predetermined objects, such as human faces. If not, go to step 203; if so, go to step 204;

Step 203: Skip the digital image;

Step 204: Detect key elements from one of the predetermined objects, such as eyes, nose, mouth, forehead, ears, chin, and face shape;

Step 205: Preprocess the predetermined object, such as aligning the face to a canonical coordinate by rotating, rescaling, and translating the human face, and improving robustness of the human face against illumination variation by performing photometric normalization on the aligned face;

Step 206: Extracting object features from the predetermined object, such as a key element vector, size of a key element, shape of a key element, textures of a key element, and colors of a key element. A key element vector can be the position of a geographic center of a key element (e.g. eyes, nose, mouth, forehead, ears, chin, and face shape) with respect to another coordinate such as an origin;

Step 207: Compare the object features with common features of each of the predetermined identifications to determine whether the predetermined object matches one of the predetermined identifications. If not, go to step 208; if so, go to step 210;

Step 208: Register the predetermined object of the digital image with a new identification;

Step 209: Check if the new identification matches with one of the predetermined identifications. If so, go to step 210; if not, go to step 213;

Step 210: Store the digital image into the database dedicated to the predetermined identification.

Step 211: Detect if there is another predetermined object contained in the digital image. If so, go to step 204; if not, go to step 212;

Step 212: Update common features of the predetermined identification after the database dedicated to the predetermined identification has received a predetermined number of additional digital images so as to improve recognition accuracy of following digital images in step 207;

Step 213: Store the digital image into the database dedicated to the new identification;

Step 214: Detect if there is another predetermined object contained in the digital image. If so, go to step 204; if not, go to step 215;

Step 215: End.

At the initial stage, there may not be any predetermined identification. In that case, the comparison of the object features extracted in step 206 with common features of each of the predetermined identifications in step 207 would conclude that the predetermined object does not match any one of the predetermined identifications. Thus the predetermined object of the digital image would be registered with a new identification (e.g. B0001) in step 208. And the digital image would be stored into the database dedicated to the new identification (B0001) in step 213.

After a predetermined number of digital images have been stored into the database dedicated to the new identification (B0001), common features of the new identification (B0001) can be generated from the object features of the predetermined object in different digital images. Once the common features of the new identification (B0001) are generated, the new identification (B0001) becomes one of the predetermined identifications. And then object features of a predetermined object extracted from a following digital image in step 206 will be compared with the common features of the identification (B0001).

As shown in step 212, although the common features of the identification (B0001) have been generated, after the database dedicated to the identification (B0001) has received a predetermined number of additional digital images, the common features of the identification (B0001) can be updated based on the object features of the predetermined object in all of the digital images stored in the database dedicated to the identification (B0001). This will increase the sturdiness of the common features of the identification (B0001).

In step 207, if the comparison result shows that the object features match common features of two or even more predetermined identifications, then the digital image would be stored into the database dedicated to the predetermined identification which matches the object features most.

In step 211 and 214, if there are other predetermined objects in the digital image, the routine has to return to step 204 until all predetermined objects in the digital image have been detected. Thus the digital image may be stored into databases corresponding to all of the predetermined objects in the digital image separately.

If step 203, instead of skipping the digital image, the digital image can be stored into a database classified as not having any predetermined object (e.g. a face), or the user may have to decide where to store the digital image.

To sum up, the present invention can organize a digital image according to facial features of members in the digital image. So a large amount of digital images can be classified automatically. This will save the user a lot of time and effort. Moreover, the user can easily retrieve digital images of a certain person simply by accessing the database dedicated to that person's identification.

Those skilled in the art will readily observe that numerous modifications and alterations of the device and method may be made while retaining the teachings of the invention.

What is claimed is:

1. A method for organizing a digital image comprising:
receiving the digital image;
checking if the digital image contains a predetermined object;
if the digital image contains the predetermined object, extracting object features from the predetermined object;
comparing the object features with common features of each predetermined identification; and
if the object features match the common features of the predetermined identification, storing the digital image into a database dedicated to the predetermined identification.

2. The method of claim 1 wherein receiving the digital image comprising receiving the digital image from a digital camera, camera-attached mobile phone, webcam, digital camcorder, or internet.

3. The method of claim 1 further comprising after checking if the digital image contains the predetermined object, if the digital image contains the predetermined object, preprocessing the predetermined object.

4. The method of claim 3 wherein preprocessing the predetermined object is performed before extracting the object features from the predetermined object.

5. The method of claim 3 wherein preprocessing the predetermined object comprises aligning the predetermined object.

6. A method for organizing a digital image comprising:
receiving the digital image;
checking if the digital image contains a predetermined object;
if the digital image contains the predetermined object, extracting object features from the predetermined object;
comparing the object features with common features of each predetermined identification; and
if the object features do not match the common features of the predetermined identification, registering the predetermined object with a new identification.

7. The method of claim 6 further comprising checking if the new identification is same as the predetermined identification.

8. The method of claim 7 further comprising if the new identification is the same as the predetermined identification, storing the digital image into a database dedicated to the predetermined identification.

9. The method of claim 8 further comprising updating common features of the predetermined identification according to object features of digital images stored in the database dedicated to the predetermined identification.

10. The method of claim 6 further comprising if the new identification is different from the predetermined identification, storing the digital image into a database dedicated to the new identification.

11. The method of claim 10 further comprising after storing a predetermined number of digital image to the database dedicated to the new identification, collecting common features of the new identification from the predetermined number of digital images.

12. The method of claim 6 further comprising after checking if the digital image contains the predetermined object, if the digital image contains the predetermined object, preprocessing the predetermined object.

13. The method of claim 12 wherein preprocessing the predetermined object is performed before extracting the object features from the predetermined object.

14. The method of claim 12 wherein preprocessing the predetermined object comprises aligning the predetermined object.

15. A method for organizing a digital image comprising:
receiving the digital image;
checking if the digital image contains a plurality of predetermined objects;
if the digital image contains the plurality of predetermined objects, extracting object features from one of the predetermined objects;
comparing the object features with common features of each predetermined identification; and
storing the digital image according to whether the object features match the common features of the predetermined identification.

16. The method of claim 15 wherein storing the digital image according to whether the object features match the common features of the predetermined identification is if the object features match the common features of the predetermined identification, storing the digital image into a database dedicated to the predetermined identification.

17. The method of claim 15 wherein storing the digital image according to whether the object features match the common features of the predetermined identification is if the object features do not match the common features of the predetermined identification, register the predetermined object with a new identification.

18. The method of claim 17 further comprising:
checking if the new identification is same as the predetermined identification; and
if the new identification is the same as the predetermined identification, storing the digital image into a database dedicated to the predetermined identification.

19. The method of claim 17 further comprising:
checking if the new identification is same as the predetermined identification; and
if the new identification is different from the predetermined identification, storing the digital image into a database dedicated to the new identification.

20. The method of claim 15 further comprising:
if the digital image contains the plurality of predetermined objects, extracting object features from another one of the predetermined objects;
comparing the object features of the another one of the predetermined objects with common features of each predetermined identification; and
storing the digital image according to whether the object features of the another one of the predetermined objects match the common features of the predetermined identification.
